(19) United States
(12) Patent Application Publication
(10) Pub. No.: US 2025/0247930 A1
(43) Pub. Date: Jul. 31, 2025

(54) LED MATRIX DRIVING SYSTEM WITH SCAN LINES AND ASSOCIATED METHOD

(71) Applicant: Chengdu Monolithic Power Systems Co., Ltd., Chengdu (CN)

(72) Inventors: Bo Yu, Hangzhou (CN); Qiming Zhao, Hangzhou (CN); Xiaofeng Shang, Hangzhou (CN); Junxin Tan, Hangzhou (CN); Qi Wang, Hangzhou (CN)

(21) Appl. No.: 19/039,260

(22) Filed: Jan. 28, 2025

(30) Foreign Application Priority Data
Jan. 29, 2024 (CN) 202410124472.1

(51) Int. Cl. H05B 45/48; H05B 45/10

(52) U.S. Cl. CPC H05B 45/48; H05B 45/10

(57) ABSTRACT

A LED matrix driving system has a micro controller with a first digital interface for providing a data write transaction pack and a monolithic integrated circuit switch device including a first terminal for receiving a power supply voltage, M scan terminals, a second digital interface and M power switches. The M scan terminals are respectively coupled to M scan lines of the LED matrix. The second digital interface is connected the first digital interface to receive the date write transaction pack. The date write transaction pack has M switch control codes for determining M switch control signals. The M power switches are connected to the M scan terminals respectively. In response to the M switch control signals, the M power switches are controlled to be turned on successively to control the LEDs of the M scan lines ON successively row by row.

### CROSS-REFERENCE TO RELATED APPLICATIONS

This application claims the benefit of CN application Ser. No. 202410124472.1, filed on Jan. 29, 2024, and incorporated herein by reference.

### TECHNICAL FIELD OF THE INVENTION

The present invention generally relates to electronic circuits, and more particularly but not exclusively, to LED matrix driving systems with scan lines and associated methods.

### BACKGROUND OF THE INVENTION

Large matrix of high-brightness light emitting diodes (“LEDs”) is more and more popular in applications such as highly pixilated light sources, high brightness LED matrix displays and automotive LED headlight systems, etc. Fast and efficient driving control to such LED matrix with multiple scan lines is desired.

### SUMMARY OF THE INVENTION

An embodiment of the present invention discloses a LED matrix driving system. The LED matrix driving system comprises a monolithic integrated circuit switch device and a micro controller with a first digital interface. The monolithic integrated circuit switch device comprises a first terminal, M scan terminals, a second digital interface and M power switches. The first terminal is configured to receive a power supply voltage. The M scan terminals are configured to be respectively coupled to M scan lines of the LED matrix. The second digital interface is configured to be connected to a first digital interface of the micro controller for receiving a date write transaction pack. The date write transaction pack at least comprises M switch control codes for determining M switch control signals. The M power switches are configured to be respectively connected to the M scan terminals. In response to the M switch control signals, the first terminal of the monolithic integrated circuit switch device is successively connected to a corresponding scan terminal for controlling the LEDs of the M scan lines ON successively row by row.

Another embodiment of the present invention discloses a driving system for a LED matrix. The LED matrix is arranged in K*M scan lines and L*N channels. The K*M scan lines are divided into K groups and each one of the K groups has M scan lines. The L*N channels are divided into L groups and each one of the L groups has N channels. The driving system comprises K integrated circuit switch devices, L integrated circuit drive devices and a micro controller. Each one of the K integrated circuit switch devices has a respective digital interface for receiving a date write transaction pack. The each one of the K integrated circuit switch devices is configured to control the LEDs of the M scan lines of the corresponding group successively ON row by row. Each one of the L integrated circuit drive devices has a respective digital interface configured to receive the data write transaction pack and is configured to provide N driving currents for the LEDs of the N channels of the corresponding group. The micro controller has a processor, a memory and a digital interface for providing the data write transaction pack. The digital interface of the micro controller, K digital interfaces of the K integrated circuit switch devices, and L digital interfaces of the L integrated circuit drive devices are coupled in series and configured in a daisy-chain architecture. The data write transaction pack is transmitted from a previous digital interface in the daisy-chain architecture to a latter digital interface in the daisy chain architecture.

Yet another embodiment of the present invention discloses a method of driving a LED matrix. The method comprises the following steps. A first terminal of a monolithic integrated circuit switch device is connected to a power supply circuit for receiving a power supply voltage. M scan terminals of the monolithic integrated circuit switch device are connected to M scan lines of the LED matrix. A digital interface of the monolithic integrated circuit switch device is connected to a digital interface of a micro controller to receive a data write transaction pack. Each bit of code of the data write transaction pack is transmitted during each clock cycle of a system clock signal. M switch control codes of the data write transaction pack are loaded into a first storage unit of the monolithic integrated circuit switch device for determining M switch control signals. In response to the M switch control signals, the first terminal of the monolithic integrated circuit switch device is successively connected to a corresponding scan terminal for controlling the LEDs of the M scan lines ON successively row by row.

### BRIEF DESCRIPTION OF DRAWINGS

The present invention can be further understood with reference to the following detailed description and the appended drawings, wherein like elements are provided with like reference numerals.

FIG. 1 illustrates a block diagram of a LED matrix driving system 100 in accordance with an embodiment of the present invention.

FIG. 2 illustrates a structure of a data write transaction pack for the LED matrix driving system 100 in accordance with an embodiment of the present invention.

FIG. 3 illustrates a block diagram of a monolithic integrated circuit switch device 201A in accordance with an embodiment of the present invention.

FIG. 4 illustrates a schematic diagram of a clamp circuit 21-x used in the monolithic integrated circuit switch device 201A in accordance with an embodiment of the present invention.

FIG. 5 illustrates a block diagram of a LED matrix driving system 100B in accordance with an embodiment of the present invention.

FIG. 6 illustrates a block diagram of a LED matrix driving system 100C in accordance with an embodiment of the present invention.

FIG. 7 illustrates a structure of a data write transaction pack for the LED matrix driving system 100C in accordance with an embodiment of the present invention.

FIG. 8 illustrates a flow diagram of a method 600 for a LED matrix driving system in accordance with an embodiment of the present invention.

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail so as not to unnecessarily obscure aspects of the present invention.

Reference to “one embodiment”, “an embodiment”, “an example” or “examples” means: certain features, structures, or characteristics are contained in at least one embodiment of the present invention. These “one embodiment”, “an embodiment”, “an example” and “examples” are not necessarily directed to the same embodiment or example. Furthermore, the features, structures, or characteristics may be combined in one or more embodiments or examples. In addition, it should be noted that the drawings are provided for illustration and are not necessarily to scale. And when an element is described as “connected” or “coupled” to another element, it can be directly connected or coupled to the other element, or there could exist one or more intermediate elements. In contrast, when an element is referred to as “directly connected” or “directly coupled” to another element, there is no intermediate element.

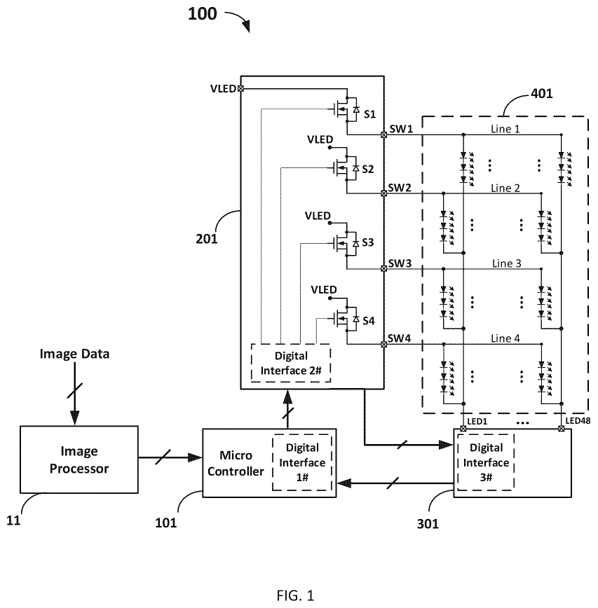

FIG. 1 illustrates a block diagram of a LED matrix driving system 100 in accordance with an embodiment of the present invention. As shown in FIG. 1, the driving system 100 is configured to drive a LED matrix 401.

Typical LED matrix for two-dimensional display is arranged to both horizontal and vertical direction as shown in FIG. 1, where horizontal direction consists of M scan lines and vertical direction consists of N channels. Where both M and N are integers higher than 1. In one embodiment shown in FIG. 1, M=4, N=48. In one embodiment, by using line scanning, the driving system 100 is configured to activate only one scan line of the LED matrix 401 at any one time.

In the embodiment shown in FIG. 1, the driving system 100 further comprises an image processor 11, a micro controller 101, a monolithic integrated circuit switch device 201 and a monolithic integrated circuit drive device 301. The image processor 11 receives image data from an external device, processes the received image data, and provides at least one of a data enable signal, a vertical synchronous signal, a horizontal synchronous signal and a clock signal, to the micro controller 101.

The micro controller 101 comprises a processor, a memory and a first digital interface. The micro controller 101 is configured to process the received signals. The first digital interface is configured to provide a data write transaction pack, a system clock signal and a load control signal and so on, to meet the requirements of the image display. Each bit of code of the data write transaction pack is transmitted during each clock cycle of the system clock signal.

In the embodiment shown in FIG. 1, the integrated circuit switch device 201 comprises a first terminal VLED, 4 scan terminals SW1˜SW4, a second digital interface and 4 power switches S1˜S4. The first terminal VLED is configured to be connected to receive a power supply voltage from a power supply circuit, to provide a drive voltage for the LED matrix 401. The 4 scan terminals SW1˜SW4 are corresponding to the 4 scan lines of the LED matrix 401. In detail, the scan terminal SW1 is connected to a scan line 1 of the LED matrix 401, the scan terminal SW2 is connected to a scan line 2, the scan terminal SW3 is connected to a scan line 3, the scan terminal SW4 is connected to a scan line 4 of the LED matrix 401.

The second digital interface of the integrated circuit switch device 201 is connected to the first digital interface of the micro controller 101. The second digital interface is configured to at least receive the date write transaction pack and the system clock signal. In one embodiment, the second digital interface may comprise 12C interface, SPI interface, etc. Each bit of code of the date write transaction pack is transmitted during each clock cycle of the system clock signal. In another embodiment, the data write transaction pack at least comprises 4 switch control codes for determining 4 switch control signals.

The 4 power switches S1˜S4 are respectively connected to the 4 scan terminals SW1˜SW4. In response to the 4 switch control signals, the 4 power switches (S1˜S4) are controlled to be turned on successively in a preset order so that the first terminal VLED is successively connected to the corresponding scan terminal. And the LEDs of the 4 scan lines are controlled to be successively ON row by row in the preset order. In one embodiment, the ON sequence of the LEDs of the 4 scan lines is not limited to the order from the scan line 1 to the scan line 4.

In the embodiment shown in FIG. 1, the monolithic integrated circuit drive device 301 comprises 48 drive terminals LED1˜LED48 and a third digital interface. The 48 drive terminals LED1˜LED48 are respectively coupled to the 48 channels of the LED matrix 401. The 48 drive terminals LED1˜LED48 are configured to provide N driving currents for the 48 channels of the LED matrix 401. The third digital interface of the monolithic integrated circuit drive device 301 is connected to the second digital interface of the monolithic integrated circuit switch device 201 to receive the data write transaction pack. The data write transaction pack is transmitted from the second digital interface to the third digital interface. In one embodiment, the data write transaction pack at least comprises N grayscale control codes for controlling the LED grayscale of the 48 channels of the LED matrix 401.

In the embodiment shown in FIG. 1, the first digital interface of the micro controller 101, the second digital interface of the monolithic integrated circuit switch device 201, and the third digital interface of the monolithic integrated circuit drive device 301 are configured in a daisy-chain architecture. Each bit of code of the data write transaction pack is transmitted to a latter digital interface from a previous digital interface in the daisy-chain architecture during each clock cycle of the system clock signal.

The embodiment of FIG. 1 shows one monolithic integrated circuit switch device 201 and one monolithic integrated circuit drive device 301, which is only for clear illustration purpose. In another embodiment, the driving system 100 may comprises K monolithic integrated circuit switch devices, L monolithic integrated circuit drive devices, to drive a LED matrix of K*M scan lines and L*N channels. The K*M scan lines are divided into K groups and each one of the K groups has M scan lines. The L*N channels are divided into L groups and each one of the L groups has N channels. In one embodiment, K digital interfaces of the K integrated circuit switch devices and L digital interfaces of the L integrated circuit drive devices are configured in a daisy-chain architecture.

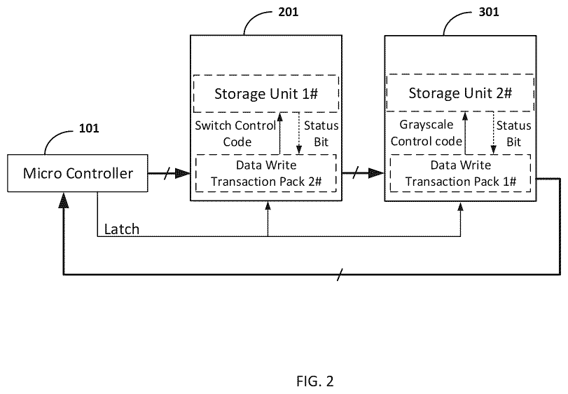

FIG. 2 illustrates a structure of a data write transaction pack for the LED matrix driving system 100 in accordance with an embodiment of the present invention. As shown in FIG. 2, the micro controller 101 is configured to be a master control unit in the daisy-chain architecture. The micro controller 101 issues the data write transaction pack to the monolithic integrated circuit switch device 201 firstly, then transmits the data write transaction pack to the monolithic integrated circuit drive device 301 from the monolithic integrated circuit switch device 201, and receives the returned data write transaction pack from the monolithic integrated circuit drive device 301 to acquire returned status data.

In one embodiment, each one of the first digital interface, the second digital interface, and the third digital interface has an input terminal configured as a daisy-chain input and an output terminal configured as a daisy-chain output. In detail, the output terminal of the first digital interface is connected to the input terminal of the second digital interface, the output terminal of the second digital interface is connected to the input terminal of the third digital interface, and the output terminal of the third digital interface is connected to the input terminal of the first digital interface.

Because of the daisy-chain architecture, the monolithic integrated circuit switch device 201 and the monolithic integrated drive device 301 have an operation similar to a relay race. As shown in FIG. 2, a first/previous data write transaction pack is driven in the third digital interface of the monolithic integrated circuit drive device 301 via the second digital interface of the monolithic integrated circuit switch device 201, at the same time, the second digital interface of the monolithic integrated circuit switch device 201 receives a second/latter data write transaction pack. In one embodiment, the first data write transaction pack comprises N grayscale control codes of determining the LED grayscale for the N channels of the LED matrix, the second data write transaction pack comprises M switch control codes for determining M switch control signals. In another embodiment, both the first and second data write transaction pack comprise the N grayscale control codes and the M switch control codes. Persons of ordinary skill in the art will understand that the data write transaction pack may also comprise other bits of code to meet the user requirements. It should be apparent to a person of ordinary skill in the field, however, that the disclosed embodiments are exemplary and not exhaustive of all possible embodiments.

In the embodiment shown in FIG. 2, the first data write transaction pack and the second data write transaction pack can be coded into a whole pack, are issued successively by the first digital interface of the micro controller 101, until all the bits of the two data write transaction packs are driven out, a round of the transmission of the data write transaction pack is over. In one embodiment, the output terminal of the first digital interface of the micro controller 101 is connected to the input terminal of the second digital interface of the monolithic integrated circuit switch device 201, to drive out all the bits of code of the first and second data write transaction packs successively.

Each bit of code of the data write transaction pack provided by the micro controller 101 is driven out during each clock cycle of the system clock signal. The system clock signal is configured to synchronize the successive transmission from the micro controller 101 to the monolithic integrated circuit switch device 201 clock by clock, and to synchronize the successive transmission from the monolithic integrated circuit switch device 201 to the monolithic integrated circuit drive device 301 clock by clock. The successive transmission is configured to have an operation that is similar to the relay race.

The system clock signal has a first type transition edge (e.g., a rising edge) and a second type transition edge (e.g., a falling edge) opposite to the first type transition edge in each clock cycle. In another embodiment, the first type transition edge is the falling edge and the second type transition edge is the rising edge.

In one embodiment, the micro controller 101 may be further configured to provide a load control signal Latch. The micro controller 101 is configured to provide the load control signal Latch after all the bits of the first and second data write transaction packs are transmitted. The load control signal Latch is asserted when the rising edge of the load control signal Latch comes. The monolithic integrated circuit switch device 201 is configured to load the switch control codes to a first storage unit of the monolithic integrated circuit switch device 201 at the rising edge of the load control signal Latch, and the monolithic integrated circuit drive device 301 is configured to load the grayscale control codes to a second storage unit of the monolithic integrated circuit drive device 301 at the rising edge of the load control signal Latch.

In one embodiment, the data write transaction pack may comprises a status flag code with one bit. In one embodiment, when a preset bit of the data write transaction pack is specified with “1” and the load control signal Latch is asserted, the monolithic integrated circuit switch device 201 and the monolithic integrated circuit drive device 301 are only configured to load the required codes into a corresponding storage unit. When the preset bit of the data write transaction pack is specified with “0” and the load control signal Latch is asserted, the integrated circuit switch device 201 and the integrated circuit drive device 301 are not only configured to load the required codes, but also to add the corresponding status bit into the data write transaction pack and to return the updated data write transaction pack to the micro controller 101 in the following transmission. In detail, as shown in FIG. 2, the integrated circuit switch device 201 is configured to load the data of status bit stored in the first storage unit into the second data write transaction pack. The data of status bit is transmitted back to the micro controller 101 via the third digital interface of the integrated circuit drive device 301. In one embodiment, the integrated circuit drive device 301 is configured to load the data of the status bit stored in the second storage unit to the first data write transaction pack. Under the control of the system clock signal, the input terminal of the first digital interface of the micro controller 101 is configured to receive the returned data of the status bit from the integrated circuit drive device 301, and to begin a next round of the transmission of the data write transaction pack.

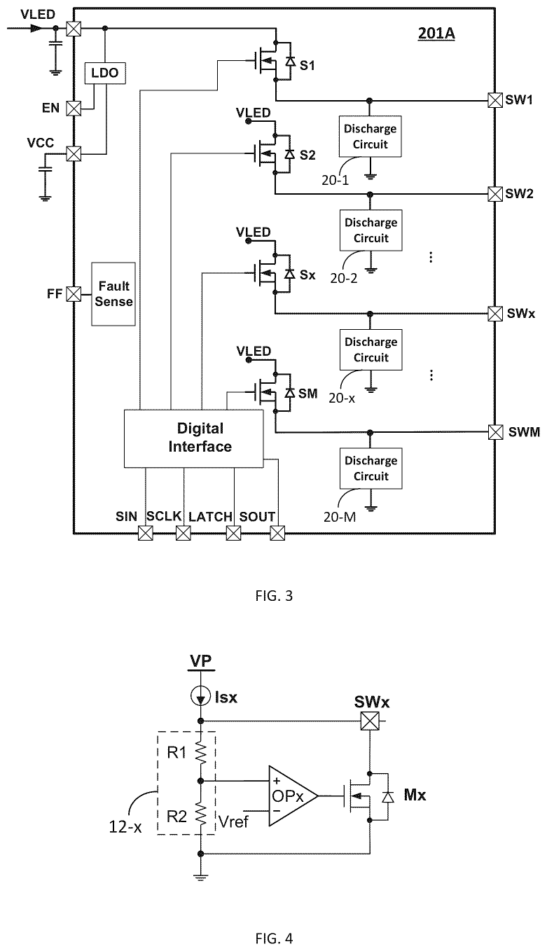

FIG. 3 illustrates a block diagram of a monolithic integrated circuit switch device 201A in accordance with an embodiment of the present invention. As shown in FIG. 3, the monolithic integrated circuit switch device 201A has a plurality of pins and M power switches S1˜SM. The plurality of pins comprise a first terminal VLED, M scan terminals SW1˜SWM, a second terminal SCLK, a third terminal SIN, a fourth terminal LATCH, a fifth terminal SOUT, a sixth terminal FF, a seventh terminal VCC and an eighth terminal EN.

The first terminal VLED is connected to receive a power supply voltage from a power supply circuit. Each power switch Sx has a first terminal, a second terminal and a control terminal. The first terminal of the power switch Sx is coupled to the first terminal VLED, the second terminal of the power switch Sx is coupled to a corresponding scan terminal SWx, the control terminal of the power switch Sx is controlled by the corresponding switch control signal. The second terminal SCLK is configured to receive the system clock signal in the daisy-chain architecture. The system clock signal has a first type transition edge (e.g., a rising edge) and a second type transition edge (e.g., a falling edge) opposite to the first type transition edge in each clock cycle. The third terminal SIN is configured to receive the data write transaction pack, and each bit of code of the date write transaction pack is transmitted at the first type transition edge of each clock cycle of the system clock signal. The fourth terminal LATCH is configured to share the load control signal Latch in the daisy-chain architecture. When the load control signal Latch is asserted, M switch control codes of the data write transaction pack are loaded into the first storage unit to provide the M switch control signals for the M power switches S1˜SM. The fifth terminal SOUT is configured to output the data write transaction pack. In response to one of the M switch control signals, the corresponding power switch Sx is turned on to connect the first terminal VLED to the corresponding scan terminal SWx, to let the LEDs of the corresponding scan line ON.

In the embodiment shown in FIG. 3, the monolithic integrated circuit switch device 201A further comprises a low drop-out regulator (LDO). The LDO is configured to receive the power supply voltage at the first terminal VLED, and provide a working voltage (e.g., VCC) at the seventh terminal VCC. The eighth terminal EN is configured to receive an enable control signal to determine if to enable the integrated circuit switch device 201A.

There is parasitic capacitance among the scan lines of the LED matrix. When a power switch Sx (x is any integer from 1 to M) corresponding to the scan line x is about to be turned off or is turned off, for example, the switch control signal corresponding to the power switch Sx changes high level from low level, there is electrical charge between the scan lines. Subsequently, when the next power switch S(x+1) corresponding to the next scan line (e.g., the scan line x+1) is turned on, the LEDs of the scan line x that do not need to be lighted will be ON slightly. In the embodiment shown in FIG. 3, the monolithic integrated circuit switch device 201A further comprises M discharge circuits 20-1˜20-M. A discharge circuit 20-x is configured to provide a discharge path from the corresponding scan terminal SWx to a ground terminal when the corresponding power switch Sx is turned off or is about to be turned off. There are not any residual electrical charges in the scan line x and the LEDs of the corresponding scan line x are OFF fully.

In detail, during the normal ON period of the power switch Sx, the rest of the M power switches are turned off, and the discharge paths from the scan terminal SWx to the ground terminal are open. When the ON period of the power switch Sx will end or ends, the discharge path from the scan terminal SWx to the ground terminal is activated by the discharge circuit 20-x, and thus a scan line voltage at the scan terminal SWx is pulled down to approach a zero voltage, to avoid a tailed current due to the residual charge in the parasitic capacitor at the scan terminal SWx. In one embodiment, the discharge circuit 20-x comprises a discharge transistor coupled between the scan terminal SWx and the ground terminal. In one embodiment, the discharge transistor is a MOSFET (Metal Oxide Semiconductor Field Effect Transistor). In other embodiment, the discharge transistor may be any controllable semiconductor devices, such as a SiC (Silicon Carbide), a GaN (Gallium Nitride) and so on.

In the embodiment shown in FIG. 3, the sixth terminal FF of the monolithic integrated circuit switch device 201A is configured to report fault status information such as undervoltage, overvoltage, overheating and short circuit and so on, to output a fault indication signal to the micro controller 101. The micro controller 101 is configured to process the received fault indication signal and to control the operation of the monolithic integrated circuit switch device 201A. In one embodiment, the monolithic integrated circuit switch device 201A comprises a fault sense circuit, e.g., a short-circuit detection circuit. The short-circuit detection circuit is activated during an OFF period of the power switch Sx. The short-circuit detection circuit is configured to determine if a voltage difference between the scan terminal SWx and the first terminal VLED is less than a short-circuit threshold voltage, and to provide the fault indication signal based on the determination.

In applications, the monolithic integrated circuit switch device 201A is configured to discharge the present scan line (e.g., the scan line 1 shown in FIG. 3) that will be OFF or has been OFF just now, and to pre-charge the next scan line (e.g., the scan line 2 shown in FIG. 3) that will be ON. This function makes sure that the LEDs of the scan line 1 is fully OFF when the LEDs of the scan line 2 will be ON, makes sure that the scan line 2 can reach an output state with a full voltage, to avoid the ghosting effect due to parasitic capacitor and the grayscale spikes effect due to the voltage increasing. However, since the scan line voltage of line 1 is pulled down to zero voltage and the scan line voltage of the line 2 is full voltage, at this time, the LEDs coupled between the scan line 1 and the scan line 2 may be subjected to a reverse voltage. To solve this problem, the monolithic integrated circuit switch device 201A further comprises the clamp circuits shown in FIG. 4.

FIG. 4 illustrates a schematic diagram of a clamp circuit 21-x used in the monolithic integrated circuit switch device 201A in accordance with an embodiment of the present invention. As shown in FIG. 4, the clamp circuit 21-x comprises a charging current source Isx, a voltage divider 12-x with resistors R1 and R2, an operational amplifier OPx and a transistor Mx.

The charging current source Isx has a power supply terminal and an output terminal. The power supply terminal of the charging current source Isx is configured to receive an internal power supply voltage VP, the output terminal of the charging current source Isx is coupled to the corresponding scan terminal SWx. The voltage divider 12-x is coupled between the corresponding terminal SWx and a ground terminal. An output terminal of the voltage divider 12-x is coupled to a non-inverting terminal of the operational amplifier OPx. An inverting terminal of the operational amplifier OPx is coupled to receive a clamp threshold voltage Vref. The output terminal of the operational amplifier OPx is coupled to a control terminal of the transistor Mx. A first terminal of the transistor Mx is coupled to the corresponding scan terminal SWx, a second terminal of the transistor Mx is coupled to the ground terminal.

In the embodiment shown in FIG. 4, after the voltage SWx at the scan terminal SWx is pulled down to zero voltage, the clamp circuit 21-x is activated to recover the voltage at the scan terminal SWx and to clamp the to the voltage at the scan terminal SWx above the clamp threshold voltage Vref.

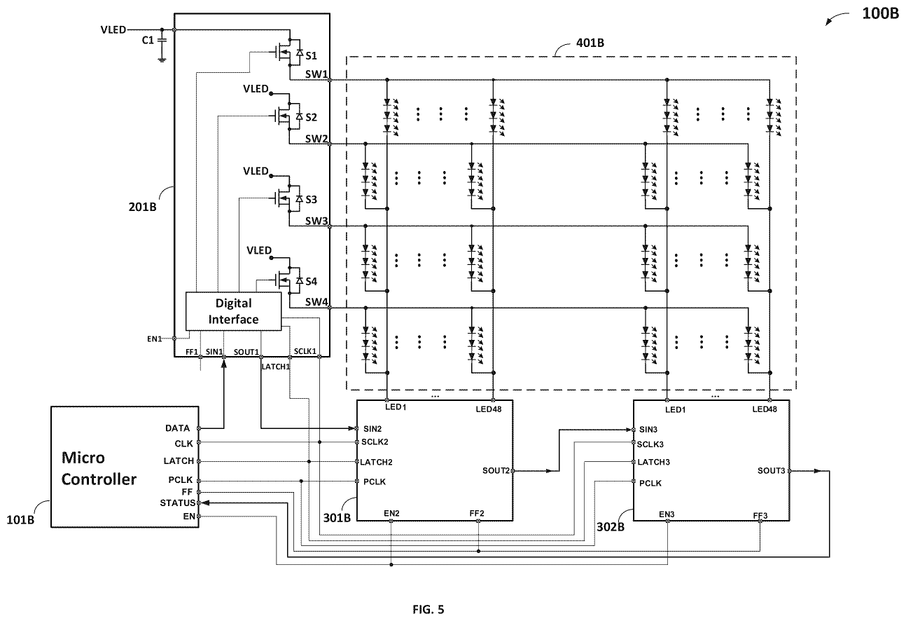

FIG. 5 illustrates a block diagram of a LED matrix driving system 100B in accordance with an embodiment of the present invention. In the embodiment shown in FIG. 5, the LED matrix 401B is arranged in M scan lines and 2*N channels, where M=4, N=48. For driving the LED matrix 401B, the driving system 100B comprises one integrated circuit switch device 201B, two integrated circuit drive devices 301B and 302B, and the micro controller 101B.

The micro controller 101B comprises a processor, a memory, a digital interface and a plurality of pins. The plurality of pins comprise a data output terminal DATA, a clock signal terminal CLK, a load control terminal LATCH, a dimming clock terminal PCLK, a fault indication terminal FF, a data input terminal STATUS and an enable terminal EN. The integrated circuit switch device 201B shown in FIG. 5 operates generally similarly as the integrated circuit switch device 201A shown in FIG. 3. As a result, operation of the integrated circuit switch device 201B in FIG. 5 is omitted for clarity.

In the embodiment shown in FIG. 5, the integrated circuit drive devices 301B and 302B both have a digital interface. Each digital interface has a plurality of pins including a data input terminal SIN, a clock signal terminal SCLK, a load control terminal LATCH, a dimming clock terminal PCLK, a fault indication terminal FF, an enable terminal EN and a data output terminal SOUT. The dimming clock terminal PCLK is configured to receive a PWM (Pulse width modulation) signal. The PWM signal is used to adjust the observed brightness of the LEDs by providing a modulated voltage to the LEDs. In one embodiment, in response to the PWM signal being high, the LEDs are ON, and in response to a the PWM signal being low, the LEDs are OFF. Changing the duty cycle of the PWM signal results in a change in observed brightness of the LEDs.

As shown in FIG. 5, the micro controller 101B, the monolithic integrated circuit switch device 201B, the monolithic integrated circuit drive devices 301 and 302B are connected and configured in a daisy-chain architecture.

Because of the daisy chain architecture, the monolithic integrated circuit switch device 201B, the monolithic integrated drive devices 301B and 302B have the operation that is similar to a relay race. This relay is carried through a SOUT→SIN loop. The terminal SOUT of each integrated circuit device is connected to the terminal SIN of the latter integrated circuit device in the daisy-chain architecture, to transmit the data write transaction pack. The LEDs of the M scan lines are controlled to be ON successively row by row.

As shown in FIG. 5, the data input terminals SIN1˜SIN3 are respectively coupled to the data output terminal DATA of the micro controller 101B, the data output terminal SOUT1 of the integrated circuit switch device 201B, and the data output terminal SOUT2 of the integrated circuit drive device 301B. The data output terminal SOUT3 is connected to the data input terminal STATUS of the micro controller 101B, to follow the relay transmission in the daisy-chain architecture. As shown in FIG. 5, the clock signal terminals SCLK1˜SCLK3 are all connected to the clock signal terminal CLK of the micro controller 101B to share the system clock signal. Each bit of code of the data write transaction pack provide by the micro controller 101B is transmitted during each clock cycle of the system clock signal. The load control terminals LATCH1˜LATCH3 are coupled to the load control terminal LATCH of the micro controller 101B, to share the load control signal Latch. The fault indication terminals FF1˜FF3 are coupled to the fault indication terminal FF of the micro controller 101B, to receive the fault indication signal. The enable terminals EN1˜EN3 are coupled to the enable terminal EN of the micro controller 101B to receive the enable control signal.

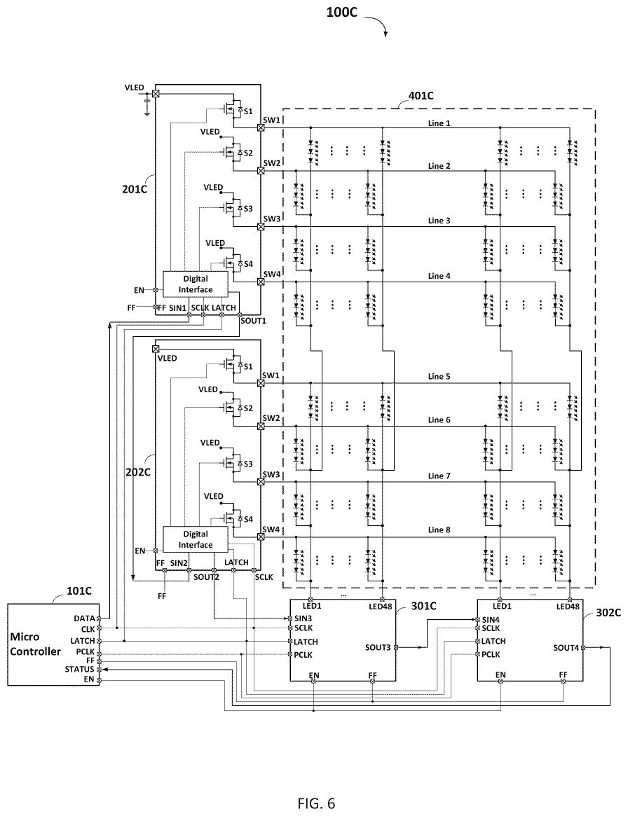

FIG. 6 illustrates a block diagram of a LED matrix driving system 100C in accordance with an embodiment of the present invention. In the embodiment shown in FIG. 6, a LED matrix 401C is arranged in 2*M scan lines and 2*N channels. Where M=4, N=48. For driving the LED matrix 401C, the driving system 100C comprises two integrated circuit switch devices 201C and 202C, two integrated circuit drive devices 301C and 302C, and the micro controller 101C.

The driving system 100C shown in FIG. 6 operates generally similarly as the driving system 100B shown in FIG. 5. As a result, the operation of the driving system 100C in FIG. 6 is omitted for clarity. As shown in FIG. 6, the micro controller 101C, the monolithic integrated circuit switch devices 201C and 202C, the monolithic integrated circuit drive devices 301C and 302C are coupled and configured in a daisy-chain architecture, have an operation that is like a relay race. The relay is carried through a SOUT→SIN loop.

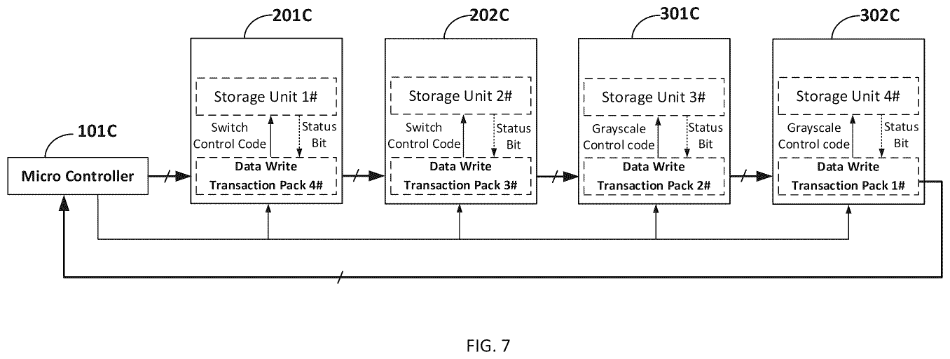

FIG. 7 illustrates a structure of a data write transaction pack for the LED matrix driving system 100C in accordance with an embodiment of the present invention. As shown in FIG. 7, the micro controller 101C is configured to work as a master control unit, to send the data write transaction pack to the monolithic integrated circuit switch device 201C, and to receive the data of the status bit returned by the integrated circuit drive device 302C.

In detail, the first to fourth data write transaction packs are transmitted by the micro controller 101C successively, until all the bits of code of the 4 data write transaction packs are sent, and a round transmission of the data write transaction pack is over. After one round transmission is over, the micro controller 101C is configured to provide an activated load control signal Latch. When the load control signal Latch is activated, the monolithic integrated circuit switch device 201C is configured to load the switch control codes of the fourth data write transaction pack into a first storage unit of the integrated circuit switch device 201C, the monolithic integrated circuit switch device 202C is configured to load the switch control codes of the third data write transaction pack into a second storage unit of the integrated circuit switch device 202C. While the monolithic integrated circuit drive device 301C is configured to load the grayscale control codes of the second data write transaction pack into a third storage unit of the integrated circuit drive device 301C, the monolithic integrated circuit drive device 302C is configured to load the grayscale control codes of the first data write transaction pack into a fourth storage unit of the integrated circuit drive device 302C.

In one embodiment, for a LED matrix of K*M scan lines and L*N channels, the driving system for driving the LED matrix comprises K monolithic integrated circuit switch devices and L monolithic integrated circuit drive devices. K monolithic integrated circuit switch devices and L monolithic integrated circuit drive devices are configured to be connected in a daisy-chain architecture, and the micro controller 101C is configured to provide K+L data write transaction packs to the integrated circuit devices in the daisy-chain architecture, to drive the LED matrix.

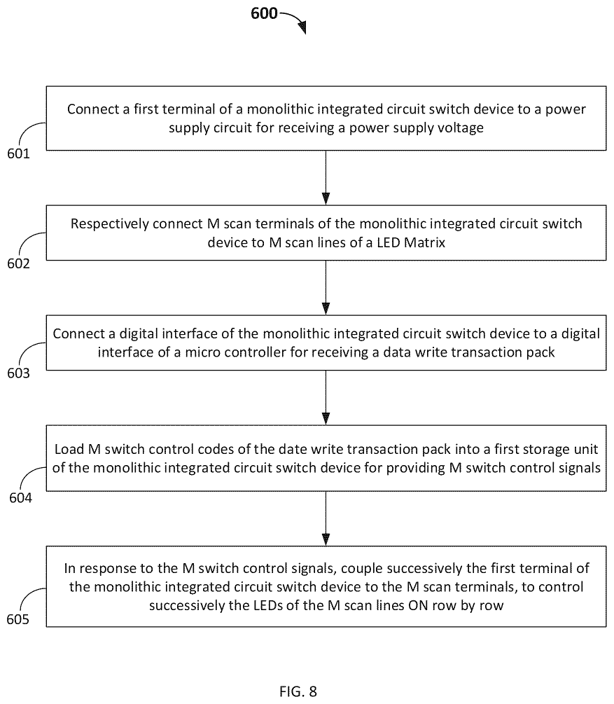

FIG. 8 illustrates a flow diagram of a method 600 for a LED matrix driving system in accordance with an embodiment of the present invention.

As shown in FIG. 8, the method 600 comprises steps 601˜605.

At step 601, a first terminal of a monolithic integrated circuit switch device is connected to a power supply circuit to receive a power supply voltage.

At step 602, M scan terminals of the monolithic integrated circuit switch device are respectively coupled to M scan lines of the LED matrix.

At step 603, a digital interface of the monolithic integrated circuit switch device is connected to a digital interface of a micro controller to receive a determined data write transaction pack. Each bit of code of the data write transaction pack is transmitted during each clock cycle of a system clock signal.

At step 604, M switch control codes of the data write transaction pack are loaded into a first storage unit of the monolithic integrated circuit switch device, to provide M switch control signals.

At step 605, in response to the M switch control signals, the first terminal of the monolithic integrated circuit switch device is connected successively to a corresponding scan terminal of the M scan terminals for controlling the LEDs of the M scan lines ON successively row by row. In one embodiment, the monolithic integrated circuit switch device comprises M power switches. In response one of the M switch control signals, the corresponding power switch is turned on to connect the first terminal of the monolithic integrated circuit switch device to the corresponding scan terminal. The LEDs of the M scan lines are controlled to be ON successively row by row.

In one embodiment, the method 600 further comprises the following steps. When a power switch is turned off, a discharge path from the corresponding scan terminal to a ground terminal is provided and activated. Subsequently, the voltage at the scan terminal is recovered to higher than a clamp threshold voltage.

In one embodiment, the method 600 further comprises the following steps. N drive terminals of a monolithic integrated circuit drive device are respectively connected to N channels of the LED matrix. A digital interface of the monolithic integrated circuit drive device is connected to the digital interface of the monolithic integrated circuit switch device for receiving the data write transaction pack. Each bit of code of the data write transaction pack is transmitted during each clock cycle of the system clock signal. N grayscale control codes of the data write transaction pack are loaded into a second storage unit of the monolithic integrated circuit drive device. The monolithic integrated circuit drive device provides N driving currents for the N channels of the LED matrix.

In one embodiment, the digital interface of the micro controller, the digital interface of the monolithic integrated circuit switch device, and the digital interface of the monolithic integrated circuit drive device are configured in a daisy-chain architecture.

In an embodiment, loading of the N grayscale control codes and the loading of the M switch control codes are both performed when a load control signal is asserted.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Obviously, many modifications and variations of the present invention are possible in light of the above teachings. It is therefore to be understood that within the scope of the appended claims the invention may be practiced otherwise than as specifically described. It should be understood, of course, the foregoing disclosure relates only to a preferred embodiment (or embodiments) of the invention and that numerous modifications may be made therein without departing from the spirit and the scope of the invention as set forth in the appended claims. Various modifications are contemplated, and they obviously will be resorted to by those skilled in the art without departing from the spirit and the scope of the invention as hereinafter defined by the appended claims as only a preferred embodiment(s) thereof has been disclosed.

What is claimed is:

1. A LED matrix driving system with a micro controller, comprising:
a monolithic integrated circuit switch device, comprising:
a first terminal configured to receive a power supply voltage;
M scan terminals configured to be respectively coupled to M scan lines of the LED matrix;
a second digital interface configured to be connected to a first digital interface of the micro controller for receiving a date write transaction pack, wherein the date write transaction pack at least comprises M switch control codes for determining M switch control signals; and
M power switches configured to be respectively connected to the M scan terminals, wherein in response to the M switch control signals, the first terminal of the monolithic integrated circuit switch device is successively connected to a corresponding scan terminal for controlling the LEDs of the M scan lines ON successively row by row.

2. The LED matrix driving system of claim 1, further comprises a monolithic integrated circuit drive device, comprising:
a third digital interface configured to be connected to the second digital interface of the monolithic integrated circuit switch device for receiving the date write transaction pack, wherein the date write transaction pack at least comprises N grayscale control codes for determining LED grayscale of N channels of the LED matrix; and
N drive terminals configured to be respectively coupled to the N channels of the LED matrix and to provide N driving currents for the N channels of the LED matrix.

3. The LED matrix driving system of claim 2, wherein:
the first digital interface, the second digital interface, and the third digital interface are configured in a daisy-chain architecture; and
wherein each bit of code of the data write transaction pack is transmitted to a latter digital interface in the daisy-chain architecture from a previous digital interface in the daisy-chain architecture during each clock cycle of a system clock signal.

4. The LED matrix driving system of claim 3, wherein:
both the monolithic integrated circuit switch device and the monolithic integrated circuit drive device have a respective load control terminal configured to acquire a load control signal; and wherein
the monolithic integrated circuit switch device is configured to load the M switch control codes of the date write transaction pack into a first storage unit of the monolithic integrated circuit switch device at a first type transition edge of the load control signal, and the monolithic integrated circuit drive device is configured to load the N grayscale control codes of the date write transaction pack into a second storage unit of the monolithic integrated circuit drive device at the first type transition edge of the load control signal.

5. The LED matrix driving system of claim 1, wherein the monolithic integrated circuit switch device further comprises:
M discharge circuits, each discharge circuit of the M discharge circuits is coupled between a corresponding scan terminal and a ground terminal of the monolithic integrated circuit switch device and is configured to provide a discharge path from the corresponding scan terminal to the ground terminal when the corresponding power switch is turned off.

6. The LED matrix driving system of claim 5, wherein the monolithic integrated circuit switch device further comprises M clamp circuits, each clamp circuit of the M clamp circuits comprises:
a charging current source having a power supply terminal and an output terminal, wherein the power supply terminal is configured to receive an internal power supply voltage, the output terminal is coupled to the corresponding scan terminal;
a voltage divider coupled between the corresponding scan terminal and the ground terminal, and having an output terminal;
an operational amplifier having a first input terminal, a second input terminal and an output terminal, wherein the first input terminal is configured to receive a reference voltage, the second input terminal is coupled to the output terminal of the voltage divider; and
a transistor having a first terminal, a second terminal and a control terminal, wherein the first terminal is coupled to the corresponding scan terminal, the second terminal is coupled to the ground terminal, and the control terminal is coupled to the output terminal of the operational amplifier.

7. The LED matrix driving system of claim 2, wherein the monolithic integrated circuit switch device further comprises a fault indication terminal for providing a fault indication signal, the micro controller is configured to receive the fault indication signal and to control the operation of the integrated circuit switch device based on the fault indication signal.

8. The LED matrix driving system of claim 7, wherein the monolithic integrated circuit switch device further comprises a short-circuit detection circuit, wherein the short-circuit detection circuit is configured to determine if a voltage between the corresponding scan terminal and the first terminal of the monolithic integrated circuit switch device is less than a short-circuit threshold voltage during an off period of the corresponding power switch and to provide the fault indication signal based on the determination.

9. A driving system for a LED matrix being arranged in K*M scan lines and L*N channels, the driving system comprising:
K integrated circuit switch devices, wherein the K*M scan lines are divided into K groups and each one of the K groups has M scan lines, each one of the K integrated circuit switch devices has a respective digital interface for receiving a date write transaction pack and is configured to control the LEDs of the M scan lines of the corresponding group successively ON row by row;
L integrated circuit drive devices, wherein the L*N channels are divided into L groups and each one of the L groups has N channels, each one of the L integrated circuit drive devices has a respective digital interface configured to receive the data write transaction pack and is configured to provide N driving currents for the LEDs of the N channels of the corresponding group; and
a micro controller having a processor, a memory and a digital interface for providing the data write transaction pack, wherein the digital interface of the micro controller, K digital interfaces of the K integrated circuit switch devices, and L digital interfaces of the L integrated circuit drive devices are coupled in series and configured in a daisy-chain architecture, the data write transaction pack is transmitted from a previous digital interface in the daisy-chain architecture to a latter digital interface in the daisy chain architecture.

10. The driving system of claim 9, wherein each bit of code in the date write transaction pack is transmitted during each clock cycle of a system clock signal.

11. The driving system of claim 9, wherein the data write transaction pack received by each integrated circuit switch device at least comprises M switch control codes.

12. The driving system of claim 9, wherein the data write transaction pack received by each integrated circuit drive device at least comprises N grayscale control codes.

13. The driving system of claim 10, wherein each integrated circuit switch device comprising:
a first terminal configured to receive a power supply voltage;
M scan terminals configured to be respectively connected to the M scan lines of the corresponding group;
a second terminal configured to receive the system clock signal;
a third terminal configured to receive the data write transaction pack from the previous digital interface in the daisy-chain architecture;
a fourth terminal configured to receive a load control signal, M switch control codes of the data write transaction pack are loaded to a first storage unit to determine M switch control signals when the load control signal is asserted;
a fifth terminal configured to be output the data write transaction pack to the latter digital interface in the daisy-chain architecture; and
M power switches configured to be connected to the M scan terminals respectively, wherein in response to the M switch control signals, the first terminal of the monolithic integrated circuit switch device is connected to a corresponding scan terminal for controlling the LEDs of the M scan lines of the corresponding group ON successively row by row.

14. The driving system of claim 13, wherein each of the L integrated circuit drive devices comprising:
N drive terminals configured to be respectively coupled to the N channels of the corresponding group and to provide N driving currents for the N channels of the corresponding group;
a first terminal configured to receive the system clock signal;
a second terminal configured to receive the data write transaction pack from the previous digital interface in the daisy-chain architecture;
a third terminal configured to receive the load control signal, N grayscale control codes of the date write transaction pack are loaded into a second storage unit when the load control signal is asserted;
a fourth terminal configured to receive a dimming control signal; and
a fifth terminal configured to output the data write transaction pack to the latter digital interface in the daisy-chain architecture.

15. A method of driving a LED matrix, comprising:
connecting a first terminal of a monolithic integrated circuit switch device to a power supply circuit for receiving a power supply voltage;
connecting M scan terminals of the monolithic integrated circuit switch device to M scan lines of the LED matrix;
connecting a digital interface of the monolithic integrated circuit switch device to a digital interface of a micro controller to receive a data write transaction pack, wherein each bit of code of the data write transaction pack is transmitted during each clock cycle of a system clock signal; and
loading M switch control codes of the data write transaction pack into a first storage unit of the monolithic integrated circuit switch device for determining M switch control signals; and wherein
in response to the M switch control signals, successively connecting the first terminal of the monolithic integrated circuit switch device to a corresponding scan terminal for controlling the LEDs of the M scan lines ON successively row by row.

16. The method of claim 15, further comprising:
respectively connecting N drive terminals of a monolithic integrated circuit drive device to N channels of the LED matrix;
connecting a digital interface of the monolithic integrated circuit drive device to the digital interface of the monolithic integrated circuit switch device for receiving the data write transaction pack; and
loading N grayscale control codes of the data write transaction pack into a second storage unit of the monolithic integrated circuit drive device for providing N driving currents for the N channels of the LED matrix.

17. The method of claim 16, wherein the digital interface of the micro controller, the digital interface of the monolithic integrated circuit switch device, and the digital interface of the monolithic integrated circuit drive device are coupled in series and configured in a daisy-chain architecture.

18. The method of claim 16, wherein the loading of the N grayscale control codes and the loading of the M switch control codes are both performed when a load control signal is asserted.

19. The method of claim 16, wherein the monolithic integrated circuit switch device comprises M power switches, the first terminal of the monolithic integrated circuit switch device is connected to the corresponding scan terminal by turning on the corresponding power switch of the M power switches.

20. The method of claim 19, further comprising:
when the corresponding power switch is turned off, providing a discharge path from the corresponding scan terminal to a ground terminal of the monolithic integrated circuit switch device; and
recovering a voltage at the corresponding scan terminal and clamping the voltage at the corresponding scan terminal above a clamp threshold voltage.
